(19) United States
(12) Patent Application Publication
(10) Pub. No.: US 2026/0127056 A1
(43) Pub. Date: May 7, 2026

(54) DETERMINING PERIOD OF NORMAL OPERATING PERFORMANCE FOR TRAINING AN ANOMALY DETECTION MODEL

(71) Applicant: Honeywell International Inc., Charlotte, NC (US)

(72) Inventors: Praveen Tayal, Hyderabad (IN); Ilangovan R, Bangalore (IN)

(21) Appl. No.: 18/937,745

(22) Filed: Nov. 5, 2024

(51) Int. Cl. G06F 11/00; G06N 20/00

(52) U.S. Cl. CPC G06F 11/004; G06N 20/00; G06F 2201/81

(57) ABSTRACT

Determining a period of normal operating performance for training an anomaly detection model is described herein. One embodiment includes receiving, by a computing device, operating data of equipment at a site over a period of time, filtering, by the computing device, the received operating data of the equipment, determining, by the computing device based on the filtered operating data of the equipment, a period of normal operating performance of the equipment during the period of time, training, by the computing device, an anomaly detection model for the equipment using the filtered operating data of the equipment during the determined period of normal operating performance of the equipment, and detecting, by the computing device using the trained anomaly detection model for the equipment, an anomaly occurring in the equipment.

### TECHNICAL FIELD

The present disclosure relates generally to devices, methods, and systems for determining a period of normal operating performance for training an anomaly detection model.

### BACKGROUND

Anomaly detection models can be used to detect when an anomaly may be occurring in equipment (e.g., pumps, compressors, exchangers, etc.) at an industrial plant, manufacturing plant, or other site. For instance, an anomaly detection model can be used to determine whether the operating data of the equipment deviates from the operating data that would be expected from normal operating performance of the equipment. To train an anomaly detection model, the normal operating performance of the equipment needs to be established to provide a performance baseline for the equipment.

### BRIEF DESCRIPTION OF THE DRAWINGS

FIG. 1 illustrates a block diagram of an example of a system for determining a period of normal operating performance for training an anomaly detection model in accordance with one or more embodiments of the present disclosure.

FIG. 2 illustrates an example of a method for determining a period of normal operating performance for training an anomaly detection model in accordance with one or more embodiments of the present disclosure.

FIGS. 3A-3B are graphs illustrating conceptual examples of determining a period of normal operating performance for training an anomaly detection model in accordance with one or more embodiments of the present disclosure.

FIG. 4 is a block diagram of an example of a computing device for determining a period of normal operating performance for training an anomaly detection model in accordance with one or more embodiments of the present disclosure.

### DETAILED DESCRIPTION

Devices, methods, and systems for determining a period of normal operating performance for training an anomaly detection model are described herein. One embodiment includes receiving, by a computing device, operating data of equipment at a site over a period of time, filtering, by the computing device, the received operating data of the equipment, determining, by the computing device based on the filtered operating data of the equipment, a period of normal operating performance of the equipment during the period of time, training, by the computing device, an anomaly detection model for the equipment using the filtered operating data of the equipment during the determined period of normal operating performance of the equipment, and detecting, by the computing device using the trained anomaly detection model for the equipment, an anomaly occurring in the equipment.

Anomaly detection models can be used to detect when an anomaly may be occurring in equipment, such as, for instance, pumps, compressors, exchanges, etc., at an industrial plant, manufacturing plant, or other type site. For instance, an anomaly detection model can be used to determine whether the operating data of the equipment, such as, for instance, temperature, pressure, flow, speed, vibration, and/or oscillation, deviates from the operating data that would be expected from normal operating performance of the equipment. To train an anomaly detection model, the normal operating performance of the equipment needs to be established to provide a performance baseline for the equipment.

In previous approaches, an engineer, technician, field operator, or other type of subject matter expert may need to visually examine and manually select the normal operating performance for the equipment. However, such a process can be difficult and time consuming, especially when there are hundreds or thousands of equipment items across a site for which a normal operating performance needs to be established.

Embodiments of the present disclosure, however, can instead utilize the operating data of the equipment to determine a period of normal operating performance of the equipment for use in training an anomaly detection model. For instance, embodiments of the present disclosure can select the normal (e.g., golden) operating period of the equipment, automatically remove outliers in the operating data, and provide filtered data that can be directly used to train the anomaly detection model. Such an approach can be quicker, easier, and/or more accurate, especially across a large scale (e.g., hundreds or thousands) of equipment items at a site, than previous approaches in which a subject matter expert manually selects the normal operating performance. Further, such an approach can be device agnostic. For instance, such an approach can be used for any type of equipment at the site.

As an example, operating data of equipment at a site over a period of time can be received. The site can be, for instance, an industrial plant or manufacturing plant, the equipment can include, for instance, pumps, compressors, and/or exchangers, and the operating data can include, for instance, temperature, pressure, flow, speed, vibration, and/or oscillation. A period of normal operating performance of the equipment during the period of time can be determined based on the operating data of the equipment, and an anomaly detection model for the equipment can be trained using the operating data of the equipment during the determined normal operating performance period. For instance, the operating data of the equipment from outside the determined normal operating performance period can be removed and not used to train the model. Anomalies occurring in the equipment can be subsequently detected using the trained anomaly detection model.

In some examples, scores for the operating data of the equipment can be determined, and the normal operating performance period of the equipment can be determined based on the determined scores. For instance, the normal operating performance period can be determined by determining which operating data of the equipment has a score that meets or exceeds a particular threshold, and the anomaly detection model can be trained using the operating data determined to have a score that meets or exceeds the threshold. As an example, a tree-based non-parametric machine learning model can be used to determine the scores, and a quantile threshold can be determined to isolate the normal operating performance period.

In some examples, the operating data of the equipment during the determined normal operating performance period can be provided to a user for validation. For instance, the operating data can be provided via a correlation matrix.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

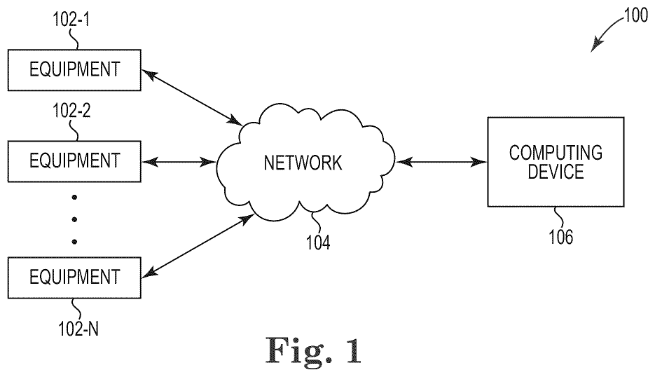

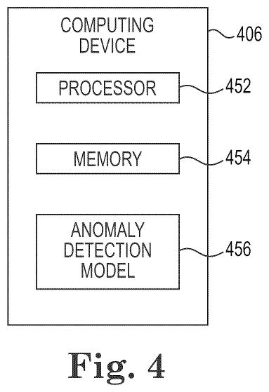

The figures herein follow a numbering convention in which the first digit or digits correspond to the drawing figure number and the remaining digits identify an element or component in the drawing. Similar elements or components between different figures may be identified by the use of similar digits. For example, 106 may reference element “08” in FIG. 1, and a similar element may be referenced as 406 in FIG. 4.

As used herein, “a”, “an”, or “a number of” something can refer to one or more such things, while “a plurality of” something can refer to more than one such things. For example, “a number of components” can refer to one or more components, while “a plurality of components” can refer to more than one component. Additionally, the designator “N”, as used herein, particularly with respect to reference numerals in the drawings, indicates that a number of the particular feature so designated can be included with a number of embodiments of the present disclosure.

FIG. 1 illustrates a block diagram of an example of a system 100 for determining a period of normal operating performance for training an anomaly detection model in accordance with one or more embodiments of the present disclosure. The system 100 can include a plurality of equipment items 102-1, 102-2, . . . , 102-N (which may be collectively referred to herein as equipment 102), and a computing device 106, as illustrated in FIG. 1.

Equipment 102 can be located at a site. The site can be, for example, an industrial plant or a manufacturing plant. Further, the site can be a large and/or complex site having hundreds or thousands of equipment items. Embodiments of the present disclosure, however, are not limited to a particular type of site.

Each respective equipment item 102 can be a different physical component located at the site (e.g., equipment item 102-1 can be a first physical component located at the site, equipment item 102-2 can be a second physical component located at the site, etc.). Equipment 102 can be located at the same location at the site, or at different locations throughout the site. In some examples, an equipment item 102 may include a number of subsystems, with each subsystem having different attributes and/or sharing common attributes.

Equipment 102 can be the same type of equipment, or equipment 102 can include different types of equipment. For instance, equipment item 102-1 can be a first type of equipment, equipment item 102-2 can be a second type of equipment, etc. As an example, equipment 102 can include one or more pumps. As an additional example, equipment 102 can include one or more compressors. As an additional example, equipment 102 can include one or more exchangers. Embodiments of the present disclosure, however, are not limited to a particular type(s) of equipment or combination of equipment.

During operation, equipment 102 can have operating data associated therewith. The operating data of equipment 102 can indicate the condition of various operating variables of the equipment (e.g., of the subsystems of the equipment). As an example, the operating data of equipment 102 can include the temperature of the equipment. As an additional example, the operating data of equipment 102 can include the pressure of the equipment. As an additional example, the operating data of equipment 102 can include the flow of the equipment. As an additional example, the operating data of equipment 102 can include the speed of the equipment. As an additional example, the operating data of equipment 102 can include the vibration of the equipment. As an additional example, the operating data of equipment 102 can include the oscillation of the equipment. Embodiments of the present disclosure, however, are not limited to a particular type(s) or combination of operating data.

For instance, a compressor can include a lube oil subsystem, a flow performance subsystem, a bearing subsystem, a motor subsystem, and a seal subsystem. The operating data of the lube oil subsystem of the compressor can include, for instance, header temperature, header pressure, and filter pressure differential. The operating data of the flow performance subsystem of the compressor can include, for instance, suction flow, suction temperature, suction pressure, discharge flow, discharge temperature, discharge temperature, and flow speed. The operating data of the bearing subsystem of the compressor can include, for instance, radial bearing temperature, radial bearing vibration, thrust bearing temperature, thrust bearing vibration, speed, and primary seal gas supply pressure. The operating data of the motor subsystem of the compressor can include, for instance, motor speed, voltage, and winding temperature. The operating data of the seal subsystem can include, for instance, primary seal gas supply pressure, differential pressure over seal gas filter, vent flow, and vent pressure.

The operating data of equipment 102 can be captured (e.g., measured) over a period of time. For instance, the operating data can be captured by the equipment itself, or by sensors associated with the equipment (not shown in FIG. 1 for simplicity and so as not to obscure embodiments of the present disclosure). The period of time can be an amount of time long enough to establish the normal operating performance of equipment 102, as will be further described herein. For instance, the period of time can be months, or greater than a year. The operating data of equipment 102 can be captured at different points throughout the period of time. For instance, the operating data can be continuously captured throughout the period of time, or can be captured at a particular interval throughout the period of time.

As shown in FIG. 1, equipment 102 (and/or the sensors associated with equipment 102) can communicate with computing device 106 via network 104. For example, equipment 102 (or the sensors associated with the equipment) can send (e.g., transmit and/or upload) the captured operating data (e.g., equipment item 102-1 can send its operating data, equipment item 102-2 can send its operating data, etc.) to computing device 106 over the period of time, and computing device 106 can receive the captured operating data from equipment 102, via network 104. In some examples, equipment 102 (and/or the sensors associated with equipment 102) can also send the times the operating data was captured (e.g., equipment item 102-1 can send the times its operating data was captured, equipment item 102-2 can send the times its operating data was captured, etc.) during the period of time to computing device 106, and computing device 106 can receive the times the operating data was captured, via network 104.

Network 104 can be a network relationship through which equipment 102 and computing device 106 can communicate. Examples of such a network relationship can include a distributed computing environment (e.g., a cloud computing environment), a wide area network (WAN) such as the Internet or a LoRaWAN, a local area network (LAN), a personal area network (PAN), a campus area network (CAN), or metropolitan area network (MAN), among other types of network relationships. For instance, network 104 can include a number of servers that receive information from, and transmit information to, equipment 102 and computing device 106 via a wired or wireless network.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices, such as computing device 106, together to form a distributed control network (e.g., cloud).

A network may provide connections to the Internet and/or to the networks of other entities (e.g., organizations, institutions, etc.). Users may interact with network-enabled software applications to make a network request, such as to get a file or print on a network printer. Applications may also communicate with network management software, which can interact with network hardware to transmit information between devices on the network.

Computing device 106 can determine (e.g., select) a period of normal operating performance of the equipment 102 during the period of time based on the operating data of equipment 102 captured over the period of time. For instance, computing device 106 can determine a period of normal operating performance of equipment item 102-1 during the period of time based on the operating data of equipment item 102-1, computing device 106 can determine a period of normal operating performance of equipment item 102-2 during the period of time based on the operating data of equipment item 102-2, etc. Normal operating performance, as used herein, can include and/or refer to, for instance, equipment 102 operating within normal (e.g., expected and/or desired) operating parameters and/or exhibiting normal (e.g., expected and/or desired) operating behavior. A period of normal operating performance can also be referred to as a golden period.

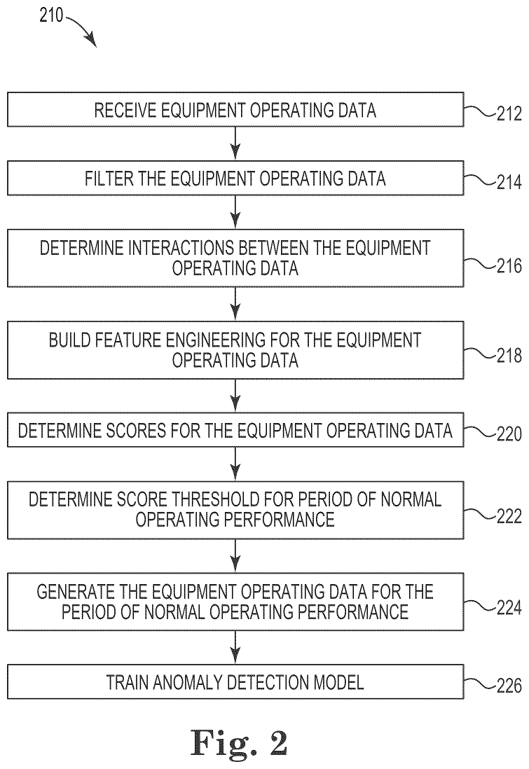

In some embodiments, computing device 106 can filter (e.g., cleanse) the operating data of equipment 102, and then determine the period of normal operating performance of the equipment during the period of time based on the filtered operating data. Filtering the operating data will be further described herein (e.g., in connection with FIG. 2).

In some embodiments, computing device 106 can determine scores (e.g., contamination scores) for the operating data of equipment 102, and determine the period of normal operating performance of the equipment during the period of time based on the determined scores. For instance, computing device 106 can determine which operating data of the equipment 102 has a score that meets or exceeds a particular threshold (e.g., a quantile threshold), and determine the period of normal operating performance of the equipment using the operating data that has a score that meets or exceeds the particular threshold (e.g., the period of normal operating performance can correspond to the time period when the operating data having a score that meets or exceeds the threshold was captured). Determining the scores, and determining the period of normal operating performance based on the scores, will be further described herein (e.g., in connection with FIG. 2).

In some embodiments, computing device 106 can determine interactions, such as, for instance, a collinearity, between the operating data of equipment 102 during the period of time, and determine the period of normal operating performance of the equipment during the period of time based on the interactions. The interactions, and determining the interactions, between the operating data of equipment 102 will be further described herein (e.g., in connection with FIG. 2).

In some embodiments, computing device 106 can provide the operating data of the equipment 102 during the determined period of normal operating performance to a user (e.g., so that the user can verify that the determined period of normal operating performance is correct), and receive a validation (e.g., verification) of the determined period of normal operating performance from the user. For instance, computing device 106 can provide a visual indication, such as a correlation matrix, of the operating data of the equipment 102 during the determined period of normal operating performance to the user. The user can be, for instance, an engineer, technician, field operator, or other subject matter expert for the site.

As an example, computing device 106 can display the operating data of the equipment 102 during the determined period of normal operating performance to the user on a user interface of computing device 106, and receive the validation of the determined period of normal operating performance from the user via the user interface. As an additional example, computing device 106 can send (e.g., transmit) the operating data of the equipment 102 during the determined period of normal operating performance to a computing device of the user, such as, for instance, a laptop, desktop, or mobile device of the user (not shown in FIG. 1 for simplicity and so as not to obscure embodiments of the present disclosure), which can display the operating data to the user. The computing device of the user can then receive the validation of the determined period of normal operating performance from the user, and send (e.g., transmit) the validation to computing device 106. Computing device 106 can send the operating data to, and receive the validation from, the computing device of the user via a wired or wireless network, such as, for instance, network 104 or a different network (not shown in FIG. 1 for simplicity and so as not to obscure embodiments of the present disclosure) through which computing device 106 and the computing device of the user can communicate.

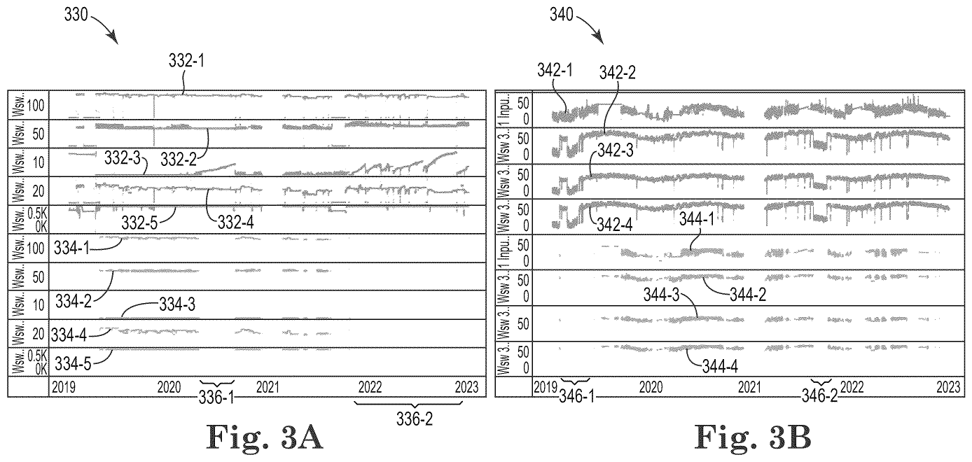

In some embodiments, computing device 106 can determine the period of normal operating performance of the equipment 102 based on the operating data for a single (e.g., only one) operating variable of the equipment. In some embodiments, computing device 106 can determine the period of normal operating performance of the equipment 102 based on the operating data for a plurality of operating variables of the equipment, such as, for instance, all operating variables of the equipment. Determining the period of normal operating performance of the equipment 102 based on the operating data for a single operating variable, and a plurality of operating variables, of the equipment will be further described herein (e.g., in connection with FIGS. 3A and 3B).

Upon determining (e.g., selecting) the period of normal operating performance of equipment 102, computing device 106 can train an anomaly detection model for the equipment using the operating data of the equipment during the determined period of normal operating performance (e.g., the operating data that was determined to have a score that meets or exceeds the particular threshold). For instance, computing device 106 can train an anomaly detection model for equipment item 102-1 using the operating data of equipment item 102-1 during the determined period of normal operating performance for equipment item 102-1, computing device 106 can train an anomaly detection model for equipment item 102-2 using the operating data of equipment item 102-2 during the determined period of normal operating performance for equipment item 102-2, etc.

The anomaly detection model can be any type of model, such as, for instance, a machine learning model, that can be used to detect when an anomaly may be occurring in equipment 102, as will be further described herein. For instance, the anomaly detection model can be any type of model that can be used to determine whether operating data of equipment 102 deviates from the operating data that would be expected from normal operating performance of the equipment. Training the anomaly detection model can include and/or refer to any type of learning process, such as, for instance, a machine learning process, that can be used to establish a performance baseline for equipment 102 for the model using the operating data of the equipment during the determined period of normal operating performance. In some examples, the anomaly detection model can be included in computing device 106.

As an example, computing device 106 can train the anomaly detection model for the equipment 102 using only the operating data of the equipment during the determined period of normal operating performance (e.g., only the operating data determined to have a score that meets or exceeds the particular threshold). For instance, computing device 106 can, prior to training the anomaly detection model, remove the operating data of equipment 102 that is from outside (e.g., was not captured during) the determined period of normal operating performance, and then train the anomaly detection model without using the operating data from outside the determined period of normal operating performance that was removed.

In some examples, the anomaly detection model can be for a subsystem of an equipment item 102, and can be trained using the operating data of that subsystem. For instance, in an example in which equipment 102 includes a compressor, the anomaly detection model can be for a lube oil subsystem of the compressor, and can be trained using the header temperature, header pressure, and filter pressure differential of the compressor during the determined period of normal operating performance of the compressor. In an additional example in which equipment 102 includes a compressor, the anomaly detection model can be for a flow performance subsystem of the compressor, and can be trained using the suction flow, suction temperature, suction pressure, discharge flow, discharge temperature, discharge temperature, and flow speed of the compressor during the determined period of normal operating performance of the compressor. In an additional example in which equipment 102 includes a compressor, the anomaly detection model can be for a bearing subsystem of the compressor, and can be trained using the radial bearing temperature, radial bearing vibration, thrust bearing temperature, thrust bearing vibration, speed, and primary seal gas supply pressure of the compressor during the determined period of normal operating performance of the compressor. In an additional example in which equipment 102 includes a compressor, the anomaly detection model can be for a motor subsystem of the compressor, and can be trained using the motor speed, voltage, and winding temperature of the compressor during the determined period of normal operating performance of the compressor. In an additional example in which equipment 102 includes a compressor, the anomaly detection model can be for a seal subsystem of the compressor, and can be trained using the primary seal gas supply pressure, differential pressure over seal gas filter, vent flow, and vent pressure of the compressor during the determined period of normal operating performance of the compressor. Embodiments of the present disclosure, however, are not limited to these examples.

In some examples, an additional anomaly detection model for equipment 102 can be trained using the operating data of the equipment during the determined period of normal operating performance of the equipment. For instance, the same equipment operating data from the determined period of normal operating performance can be used to train multiple anomaly detection models for the equipment.

After the anomaly detection model has been trained, computing device 106 can use the trained anomaly detection model to detect an anomaly occurring in the equipment 102. For example, after the anomaly detection model has been trained (e.g., after the period of time), computing device can receive, via network 104, operating data of equipment 102 in a manner analogous to that previously described herein. Computing device 106 can use the trained anomaly detection model to determine a deviation of this operating data from the operating data of the equipment 102 during the period of normal operating performance of the equipment, and determining an anomaly is occurring in the equipment based on this deviation. For instance, computing device 106 can determine an anomaly is occurring in the equipment 102 if the deviation meets or exceeds a pre-defined threshold for the equipment.

Upon detecting an anomaly occurring in the equipment 102, computing device 106 can provide an alert to a user (e.g., engineer, technician, field operator, etc.). For example, computing device 106 can display the alert to the user on a user interface of computing device 106. As an additional example, computing device 106 can send (e.g., transmit) the alert to a computing device of the user, such as, for instance, a laptop, desktop, or mobile device of the user (not shown in FIG. 1 for simplicity and so as not to obscure embodiments of the present disclosure), which can provide the alert to the user. Computing device 106 can send the alert to the computing device of the user via a wired or wireless network, such as, for instance, network 104 or a different network (not shown in FIG. 1 for simplicity and so as not to obscure embodiments of the present disclosure) through which computing device 106 and the computing device of the user can communicate. Upon receiving the alert, the user can trigger an action address the anomaly.

FIG. 2 illustrates an example of a method 210 for determining a period of normal operating performance for training an anomaly detection model in accordance with one or more embodiments of the present disclosure. Method 210 can be performed by, for example, computing device 106 previously described in connection with FIG. 1.

At block 212, method 210 includes receiving operating data of equipment. The operating data can be, for example, operating data of equipment 102 previously described in connection with FIG. 1, and can be received over a period of time, as previously described in connection with FIG. 1.

At block 214, method 210 includes filtering (e.g., cleansing) the received operating data of the equipment. Filtering the operating data can include, for example, applying an operation mode filter and/or a condition mode filter to the data. The operating mode filter can filter the data based on the operating mode of the equipment (e.g., low or high), and the condition mode filter can filter the data based on the condition of the equipment (e.g., higher or lower than a threshold).

At block 216, method 210 includes determining interactions between the equipment operating data (e.g., between the filtered equipment operating data). The interactions can include a collinearity, such as a multicollinearity, between the operating data of the equipment. A collinearity between the equipment operating data can indicate that two operating variables of the equipment may be trending together, such as, for instance, one increasing when the other increases or one decreasing when the other decreases. The interactions can also include a feature selection, which can indicate how the operating variables of the equipment interact with and/or are dependent on other operating variables of the equipment.

At block 218, method 210 includes building a feature engineering for the equipment operating data (e.g., for the filtered equipment operating data). The feature engineering can include feature interactions between the equipment operating data, which can be additional features derived based on the results of block 216. As an example, the feature engineering can be built by performing a statistical operation, such as, for instance, an addition operating or a multiplication operation, on the equipment operating data based on the determined interactions between the equipment operating data.

At block 220, method 210 includes determining scores for the equipment operating data (e.g., for the filtered equipment data for which interactions have been determined and a feature engineering has been built). For example, a score for each respective equipment data point can be determined. The scores can be, for instance, contamination scores, and the score for each respective equipment data point can indicate (e.g., reflect) the probability (e.g., likelihood) that data point corresponds to normal operating performance of the equipment. For instance, the scores can be expressed on a scale from +1 to −1, with a greater (e.g., more positive) score indicating a greater probability that data point corresponds to (e.g., indicates) normal operating performance of the equipment (e.g., the higher the score, the more likely that data point corresponds to normal operating performance), and a lower (e.g., more negative) score indicating a lower probability that data point corresponds to (e.g., indicates) normal operating performance of the equipment (e.g., the lower the score, the more likely that data point does not correspond to normal operating performance).

The scores for the equipment operating data can be determined using a machine learning model, such as, for instance, a tree-based non-parametric machine learning model. For instance, the machine learning model can be applied to the equipment operating data (e.g., to the filtered equipment data for which interactions have been determined and a feature engineering has been built) to determine the scores.

At block 222, method 210 includes determining a score threshold for a period of normal operating performance for the equipment. The score threshold can be, for instance, a quantile threshold, and can be used to determine (e.g., isolate) the period of normal operating performance of the equipment (e.g., by providing a range of scores that correspond to normal operating performance of the equipment). For instance, continuing in the previous example in which the scores are expressed on a scale from +1 to −1, the score threshold can correspond to the minimum score value that an equipment data point would need to have to qualify as corresponding to normal operating performance of the equipment (e.g., a data point with a score lower than that threshold would not correspond to normal operating performance of the equipment).

At block 224, method 210 includes generating the equipment operating data for the period of normal operating performance (e.g., based on the scores determined at block 220 and the score threshold determined at block 222). For instance, the equipment operating data having a score that meets or exceeds the score threshold can be generated and used to determine the period of normal operating performance (e.g., the period of normal operating performance can correspond to the time period when the operating data having a score that meets or exceeds the score threshold was captured).

In some embodiments, the generated equipment operating data can be provided to a user for validation, as previously described herein. For instance, a visual indication (e.g., a correlation matrix) of the generated equipment operating data can be provided to the user, as previously described herein.

At block 226, method 210 includes training an anomaly detection model (e.g. using the equipment operating data for the period of normal operating performance generated at block 224). The anomaly detection model can be any type of model, such as, for instance, a machine learning model, that can be used to detect when an anomaly may be occurring in the equipment, as previously described herein, and can be trained as previously described herein.

FIG. 3A is a graph 330 illustrating a conceptual example of determining a period of normal operating performance for training an anomaly detection model in accordance with one or more embodiments of the present disclosure. FIG. 3B is a graph 340 illustrating another conceptual example of determining a period of normal operating performance for training an anomaly detection model in accordance with one or more embodiments of the present disclosure.

Graphs 330 and 340 include (e.g., illustrate) examples of operating data of equipment, such as, for instance, equipment 102 previously described in connection with FIG. 1, captured over a period of time, as previously described herein. For example, graph 330 includes operating data 332-1, 332-2, 332-3, 332-4, and 332-5 (which may be collectively referred to herein as operating data 332) of a first equipment item over a period of time, and graph 340 includes operating data 342-1, 342-2, 342-3, and 342-4 (which may be collectively referred to herein as operating data 342) of a second equipment item over a period of time. The period of time can be, for example, four years (e.g., 2019-2023), as illustrated in FIGS. 3A and 3B.

The operating data included in graphs 330 and 340 can indicate the condition of various operating variables of the equipment, as previously described herein. For instance, operating data 332-1 can indicate the condition of a first operating variable of the first equipment item, operating data 332-2 can indicate the condition of a second operating variable of the first equipment item, operating data 332-3 can indicate the condition of a third operating variable of the first equipment item, operating data 332-4 can indicate the condition of a fourth operating variable of the first equipment item, and operating data 332-5 can indicate the condition of a fifth operating variable of the first equipment item,. Further, operating data 342-1 can indicate the condition of a first operating variable of the second equipment item, operating data 342-2 can indicate the condition of a second operating variable of the second equipment item, operating data 342-3 can indicate the condition of a third operating variable of the second equipment item, and operating data 342-4 can indicate the condition of a fourth operating variable of the second equipment item.

Graphs 330 and 340 also include (e.g., illustrate) the operating data of the equipment during the period of time determined to correspond to the normal operating performance of the equipment, which can be used to determine the period of normal operating performance of the equipment, as previously described herein. For example, graph 330 includes the operating data 334-1, 334-2, 334-3, 334-4, and 334-5 (which may be collectively referred to herein as operating data 334) of the first equipment item during the period of time that corresponds to the normal operating performance of the first equipment item, and graph 340 includes the operating data 344-1, 344-2, 344-3, and 344-4 (which may be collectively referred to herein as operating data 344) of the second equipment item during the period of time that corresponds to the normal operating performance of the second equipment item.

Operating data 334 can be used to determine the period of normal operating performance of the first equipment item, and operating data 344 can be used to determine the period of normal operating performance of the second equipment item. For instance, the gaps in operating data 334, such as those during time periods 336-1 and 336-2 illustrated in FIG. 3A, correspond to portions of operating data 332 that have been determined to be from outside the period of normal operating performance of the first equipment item, and thus have been removed and not included in operating data 334 (e.g., only the portions of operating data 332 that correspond to the normal operating performance of the first equipment item are included in operating data 334). Further, the gaps in operating data 344, such as those during time periods 346-1 and 346-2 illustrated in FIG. 3B, correspond to portions of operating data 342 that have been determined to be from outside the period of normal operating performance of the first equipment item, and thus have been removed and not included in operating data 344 (e.g., only the portions of operating data 342 that correspond to the normal operating performance of the second equipment item are included in operating data 344). Operating data 334 can be used to train an anomaly detection model for the first item of equipment and operating data 344 can be used to train an anomaly detection model for the second item of equipment, as previously described herein.

In the example illustrated in FIG. 3A, the period of normal operating performance of the first equipment item can be determined based on the operating data for a single (e.g., only one) operating variable of the first equipment item. For example, the first equipment item can be determined to be outside of its normal operating performance if only one of its operating variables is outside of its normal operating performance. For instance, during time period 336-1 illustrated in FIG. 3A, only operating data 332-3 may be determined to be outside the normal operating performance of the first equipment item (e.g., operating data 332-1, 332-2, 332-4, and 332-5 may correspond to normal operating performance). However, there is a gap in operating data 334 during this time period, indicating this time period has been determined to be outside the period of normal operating performance of the first equipment item.

In the example illustrated in FIG. 3B, the period of normal operating performance of the second equipment item can be determined based on the operating data for a plurality of (e.g., all) the operating variables of the second equipment item (e.g., the period of normal operating performance can be determined based on context). For example, the second equipment item can be determined to be outside of its normal operating performance if multiple of its operating variables is outside of their normal operating performance. For instance, during time period 346-2 illustrated in FIG. 3B, operating data 342-1 may correspond to normal operating performance of the second equipment item, but operating data 342-2, 342-3, and 342-4 may be determined to be outside the normal operating performance of the second equipment item. Accordingly, there is a gap in operating data 344 during this time period, indicating this time period has been determined to be outside the period of normal operating performance of the second equipment item. However, in the example illustrated in FIG. 3B, the second equipment item can be determined to be within its normal operating performance if only one of its operating variables is outside of its normal operating performance (e.g., but its other operating variables correspond to normal operating performance).

FIG. 4 is a block diagram of an example of a computing device 406 for determining a period of normal operating performance for training an anomaly detection model in accordance with one or more embodiments of the present disclosure. Computing device 406 can be, for example, computing device 106 previously described in connection with FIG. 1.

As illustrated in FIG. 4, the computing device 406 can include an anomaly detection model 456, and a memory 454 and a processor 452 for determining a period of normal operating performance for training anomaly detection model 456, in accordance with the present disclosure. Anomaly detection model 456 can be any type of model, such as, for instance, a machine learning model, that can be used to detect when an anomaly may be occurring in equipment, such as equipment 102 previously described in connection with FIG. 1, as previously described herein.

The memory 454 can be any type of storage medium that can be accessed by the processor 452 to perform various examples of the present disclosure. For example, the memory 454 can be a non-transitory computer readable medium having computer readable instructions (e.g., executable instructions/computer program instructions) stored thereon that are executable by the processor 452 for determining a period of normal operating performance for training anomaly detection model 456 in accordance with the present disclosure.

The memory 454 can be volatile or nonvolatile memory. The memory 454 can also be removable (e.g., portable) memory, or non-removable (e.g., internal) memory. For example, the memory 454 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 454 and anomaly detection model 456 are illustrated as being located within computing device 406, embodiments of the present disclosure are not so limited. For example, memory 454 and/or anomaly detection model 456 can also be located internal to another computing resource (e.g., enabling computer readable instructions to be downloaded over the Internet or another wired or wireless connection).

The processor 452 may be a central processing unit (CPU), a semiconductor-based microprocessor, and/or other hardware devices suitable for retrieval and execution of machine-readable instructions stored in memory 454.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving, by a computing device, operating data of equipment at a site over a period of time;
filtering, by the computing device, the received operating data of the equipment;
determining, by the computing device based on the filtered operating data of the equipment, a period of normal operating performance of the equipment during the period of time;
training, by the computing device, an anomaly detection model for the equipment using the filtered operating data of the equipment during the determined period of normal operating performance of the equipment; and
detecting, by the computing device using the trained anomaly detection model for the equipment, an anomaly occurring in the equipment.

2. The method of claim 1, wherein determining the period of normal operating performance of the equipment during the period of time includes:
determining scores for the filtered operating data of the equipment; and
determining the period of normal operating performance of the equipment based on the determined scores.

3. The method of claim 2, wherein:
determining the period of normal operating performance of the equipment based on the determined scores includes determining which operating data of the equipment has a score that meets or exceeds a particular threshold; and
the anomaly detection model is trained using the filtered operating data of the equipment determined to have a score that meets or exceeds the particular threshold.

4. The method of claim 1, wherein determining the period of normal operating performance of the equipment during the period of time includes:
determining interactions between the filtered operating data of the equipment during the period of time; and
determining the period of normal operating performance of the equipment based on the determined interactions between the filtered operating data.

5. The method of claim 4, wherein the interactions include a collinearity between the filtered operating data of the equipment during the period of time.

6. The method of claim 1, wherein the method includes providing, by the computing device, the filtered operating data of the equipment during the determined period of normal operating performance of the equipment to a user.

7. The method of claim 6, wherein the method includes receiving, by the computing device, a validation of the determined period of normal operating performance of the equipment from the user.

8. A computing device, comprising:
an anomaly detection model for equipment at a site;
a processor; and
a memory storing non-transitory machine-readable instructions to cause the processor to:
receive operating data of equipment at a site over a period of time;
determine scores for the operating data of the equipment;
determine a period of normal operating performance of the equipment during the period of time based on the determined scores for the operating data of the equipment;
train the anomaly detection model using the operating data of the equipment during the determined period of normal operating performance of the equipment; and
detect an anomaly occurring in the equipment using the trained anomaly detection model.

9. The computing device of claim 8, wherein the instructions cause the processor to provide an alert upon detecting the anomaly occurring in the equipment.

10. The computing device of claim 8, wherein the instructions cause the processor to remove the operating data of the equipment that is from outside the determined period of normal operating performance of the equipment prior to training the anomaly detection model.

11. The computing device of claim 8, wherein the instructions cause the processor to determine the period of normal operating performance of the equipment based on the determined scores for the operating data for a single operating variable of the equipment.

12. The computing device of claim 8, wherein the instructions cause the processor to determine the period of normal operating performance of the equipment based on the determined scores for the operating data for a plurality of operating variables of the equipment.

13. The computing device of claim 8, wherein the instructions cause the processor to detect an anomaly occurring in the equipment using the trained anomaly detection model by:
receiving operating data of the equipment after the period of time; and
determining, by the trained anomaly detection model, a deviation of the operating data of the equipment after the period of time from the operating data of the equipment during the determined period of normal operating performance of the equipment.

14. The computing device of claim 8, wherein the anomaly detection model is for at least one of:
a lube oil system of the equipment;
a flow performance of the equipment;
a bearing of the equipment;
a motor of the equipment; and
a seal of the equipment.

15. A non-transitory computer readable medium storing instructions executable by a processing resource to cause the processing resource to:
receive operating data of equipment at a site over a period of time;
determine a period of normal operating performance of the equipment during the period of time based on the operating data of the equipment;
remove the operating data of the equipment that is from outside the determined period of normal operating performance of the equipment;
train an anomaly detection model for the equipment using only the operating data of the equipment during the determined period of normal operating performance of the equipment; and
detect an anomaly occurring in the equipment using the trained anomaly detection model.

16. The computer readable medium of claim 15, wherein training the anomaly detection model using only the operating data of the equipment during the determined period of normal operating performance of the equipment comprises training the anomaly detection model without using the operating data of the equipment that is from outside the determined period of normal operating performance of the equipment.

17. The computer readable medium of claim 15, wherein the instructions are executable to train an additional anomaly detection model for the equipment using only the operating data of the equipment during the determined period of normal operating performance of the equipment.

18. The computer readable medium of claim 15, wherein the instructions are executable to:
receive operating data of additional equipment at the site over the period of time;
determine a period of normal operating performance of the additional equipment during the period of time based on the operating data of the additional equipment;
remove the operating data of the additional equipment that is from outside the determined period of normal operating performance of the additional equipment; and
train an anomaly detection model for the additional equipment using only the operating data of the additional equipment during the determined period of normal operating performance of the additional equipment.

19. The computer readable medium of claim 15, wherein the operating data of the equipment includes at least one of:
a temperature of the equipment;
a pressure of the equipment;
a flow of the equipment;
a speed of the equipment;
a vibration of the equipment; and
an oscillation of the equipment.

20. The computer readable medium of claim 15, wherein the equipment at the site includes at least one of:
a pump;
a compressor; and
an exchanger.
